(19) United States
(12) Patent Application Publication
(10) Pub. No.: US 2009/0254754 A1
(43) Pub. Date: Oct. 8, 2009

(54) LIGHTWEIGHT GEOGRAPHIC TRAJECTORY AUTHENTICATION VIA ONE-TIME SIGNATURES

(75) Inventors: Bhargav Ramchandra Bellur, Bangalore (IN); Aravind V. Iyer, Bangalore (IN)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/413,741

(22) Filed: Mar. 30, 2009

Related U.S. Application Data
(60) Provisional application No. 61/042,406, filed on Apr. 4, 2008.

(51) Int. Cl. H04L 9/32; G08G 1/16

(52) U.S. Cl. 713/176; 340/903

(57) ABSTRACT

A system and method for a vehicle-to-vehicle communications system that provide active safety applications employing lightweight geographic authentication using one-time signatures. The system and method require each vehicle to construct a discretized representation of its trajectory, which captures its kinematical history to a tunable degree of accuracy and to a tunable extent in the past. This trajectory information is then signed using a one-time signature. Thus, with every periodic message, the sending vehicle transmits the usual application payload, a signed version of the trajectory as described, and the digital signature over all of the fields.

### CROSS-REFERENCE TO RELATED APPLICATIONS

This application claims the benefit of the priority date of U.S. Provisional Patent Application Ser. No. 61/042,406, titled Lightweight Geographic Trajectory Authentication Via One-Time Signatures, filed Apr. 4, 2008.

### BACKGROUND

1. Field of the Invention

A system and method for providing safety applications using vehicle-to-vehicle (V2V) communications and, more particularly, to a system and method for providing safety applications in V2V communications, where the system and method employ lightweight geographic trajectory authentication using one-time signatures.

2. Discussion of the Related Art

Vehicle-to-vehicle safety applications, such as blind spot warning (BSW) systems and cooperative collision warning (CCW) systems, rely on periodic V2V communications, such as the wireless dedicated short range communications (DSRC) standard. These messages are typically transmitted at 10 Hz per vehicle, and are typically authenticated using digital signatures based on an underlying public key infrastructure (PKI) in accordance with the IEEE 1609.2 standard specification.

Each principal in a PKI system has a pair of keys, namely a private key and a public key. The private key is known only to the principal and the public key can be shared with other entities in the system. The keys can be visualized as a pair of functions Pᵣ and Pᵤ representing the private and public keys, respectively, and having the property M=Pᵣ(Pᵤ(M)) and M=Pᵤ(Pᵣ(M)), where M is the message that is to be secured using the keys. To ensure message integrity, the sender of the message signs the message with its private key, and adds this signature to the message. Upon receiving the message, the recipient can verify the signature of the message using the sender's public key.

A fundamental problem in the PKI architecture is the exchange of the public keys without compromising them. One widely accepted solution is for a trusted entity, known as a certifying authority (CA), to digitally sign data structures, known as certificates, that state the binding nature between names and public keys. In the case of the IEEE 1609.2 standard, a certificate includes several fields, namely the public key, geographic scope or region of the certificate, a certified revocation list series number associated with the certificate, the expiration time of the certificate and the signature of the CA. In order to verify the certificates signed by the CA, the public key of the CA must be available at each entity of the PKI system. Because the distribution of all of the certificates issued by the CA is impractical, the IEEE 1609.2 standard specifies that a sender should add its certificate to a signed message.

Generating and verifying digital signatures consumes a non-negligible amount of the share of an automotive processor. As the penetration of V2V-based active safety applications increases, two related problems are expected to arise.

Given the limited computational speed of the automotive processor, signing and verifying each periodic message by digital signatures would become infeasible as the number of neighboring vehicles increases. Hence, there is a need for efficient mechanisms for authentication of periodic message broadcasts by V2V safety applications. Also, as the density of V2V-equiped vehicles increases, vehicles will experience increased contention for accessing the broadcast wireless medium, potentially leading to increased data packet collisions. This leads to loss of messages, and may affect the accuracy of the applications, such as BSW and CCW, which are expected to depend on the kinematic history of neighboring vehicles to raise alerts. Hence, there is a need to convey authentic trajectory information within V2V periodic messages that enables the application resident on the receiving vehicle to re-construct the trajectory of the sending vehicle in spite of frequent message loss.

As far as the problem of efficient broadcast authentication is concerned, there are various techniques available in the literature to address this problem. However, none of these available approaches is completely satisfactory. In particular, digital signatures result in high computational overhead, while one-time signatures, such as Merkle-Winternitz signatures, result in high communication overhead, and lightweight protocols, such as timed efficient stream loss-tolerant authentication (TESLA), result in delayed message authentication. Further, in one-time signatures, such as the Merkle-Winternitz signature, there is a trade-off between the computational overhead and the communication overhead, both of which increase in proportion with the number of bits being signed.

A brief description of the TESLA protocol is provided including its drawbacks in the vehicular context. This provides the motivation for modifications to the TESLA protocol for Vehicle Ad-Hoc Networks (VANETs), which are then presented. The TESLA protocol is described in the context of a single sender and multiple receivers. The protocol is based on the delayed disclosure of symmetric keys. Initially, a sender appends to each message, a message authentication code (MAC) based on a symmetric key known only to itself. The receiver buffers the message without being able to authenticate them, which results in message verification delay. A short time later, when the sender discloses the symmetric key, the receiver is able to authenticate buffered messages. The TESLA protocol is based on the property of loose time synchronization i.e., the receiver knows an upper bound on the sender's local time.

The sender divides time into L intervals of length T_{INT} and computes a one-way hash-chain as described below. For a one-way has function H(.), let H⁰(K)=K and let Hⁱ⁺¹(K)=H(Hⁱ(K)) for integer values i≧0. The TESLA protocol also has a parameter called the key disclosure delay d expressed in units of the interval length T_{INT}. At the start time T₀, the sender computes the hash-chain, denoted by [K,H(K),H²(K), . . . H^{L}(K), . . . H^{L+d}(K)]. The sender decides on the symmetric keys that will be used to sign a message in each interval, and the symmetric key that is disclosed in each interval.

At the sender, the TESLA protocol divides time into intervals of length T_{INT}. The figure below depicts the signing key as well as the disclosed key in each interval. Note that the sequence of signing keys assigned to each time interval is in the reverse order of the hash chain.

At the beginning of each round (at time T₀), the sender transmits the key disclosure schedule in an authentic manner to all receivers. This message is signed with a digital signature, and requires support of the PKI security framework. The key disclosure schedule is denoted as (T₀,T_{INT},L,d,H^{L+d}(K)) and consists of a time interval schedule, a start time T₀ interval duration T_{INT} and number of intervals L, a key disclosure delay d expressed in number of intervals, and a commitment to the hash-chain H^{L+d}(K).

When transmitting a packet, the sender appends a MAC based on the signing key corresponding to that time interval. In addition, the signing key corresponding to d intervals in the past is disclosed. Upon receiving a packet, the receiver verifies that the disclosed key is part of the hash-chain. The disclosed key is then used to verify buffered packets and determines the interval i in which the packet was transmitted based on the disclosed key in the packet. Based on loose time synchronization, and its current time, the receiver infers the latest possible interval x in which the sender could currently be in, and if (x<i+d), the receiver buffers the packet for delayed verification. Otherwise if x≧i+d, it discards the packet as unsafe.

The primary advantage of TESLA is a significant improvement in the signing and verification time since the majority of messages are authenticated via a MAC based on a symmetric key. However, TESLA requires clock synchronization at the nodes, and messages cannot be verified until the corresponding symmetric key is disclosed by the sender. Note that the parameters d and T_{INT} of the TESLA protocol have to be carefully selected in order for the protocol to work well.

In the context of a VANET with highly mobile nodes, observe that for a given sender, the set of receivers will change frequently. Hence, one drawback of the TESLA protocol, as described above, is that the mandatory reception of the key disclosure schedule message cannot be guaranteed. In addition, V2X safety applications transmit real-time kinematics information, such as position, velocity, direction, etc., in the message payload. For the basic version of the TESLA protocol described above, the minimum value of the parameter d is 2. Hence, with T_{INT}=100 ms and d=2, the least time duration after which a message would be verified is 200 ms. This verification delay may be too large for V2X safety applications, such as collision avoidance applications. Note that a vehicle traveling at 120 kmph (33.3 meters per sec) would have moved 6.6 meters in 200 ms.

### SUMMARY

A system and method are disclosed for a vehicle-to-vehicle communications system that provides active safety applications employing lightweight geographic authentication using one-time signatures. The system and method require each vehicle to construct a discretized representation of its trajectory, which captures its kinematical history to a tunable degree of accuracy and to a tunable extent in the past. This trajectory information is then signed using a one-time signature. Thus, with every periodic message, the sending vehicle transmits the usual application payload, a signed version of the trajectory as described, and the digital signature over all of the fields.

Additional features will become apparent from the following description and appended claims, taken in conjunction with the accompanying drawings.

### BRIEF DESCRIPTION OF THE DRAWINGS

FIG. 1 is a plan view of a vehicle employing a vehicle-to-vehicle communications system;

FIG. 2 is an illustration of node mobility showing each message appended with dual authenticators;

FIG. 3 is a graph showing vehicle trajectories;

FIG. 4 is a schematic diagram of message flow in a vehicle-to-vehicle communications message from the application layer to the physical channel;

FIG. 5 is a plan view of a Merkle-Winternitz one-time signature mechanism; and

FIG. 6 is a representation of a message appended with a PKI-based digital signature, a TESLA MAC and a one-time digital signature.

The following discussion of the embodiments are directed to a system and method for providing active safety applications in a vehicle-to-vehicle communications system employing lightweight geographic trajectory authentication using one-time signatures is merely exemplary in nature, and is in no way intended to limit the invention or its applications or uses.

### DETAILED DESCRIPTION

The following discussion is directed to exemplary embodiments of a system and method for providing active safety applications in a vehicle-to-vehicle communications system that employs lightweight geographic trajectory authentication using one-time signatures. The embodiments set forth herein are merely exemplary in nature, and are in no way intended to limit the scope of the invention, its applications or uses.

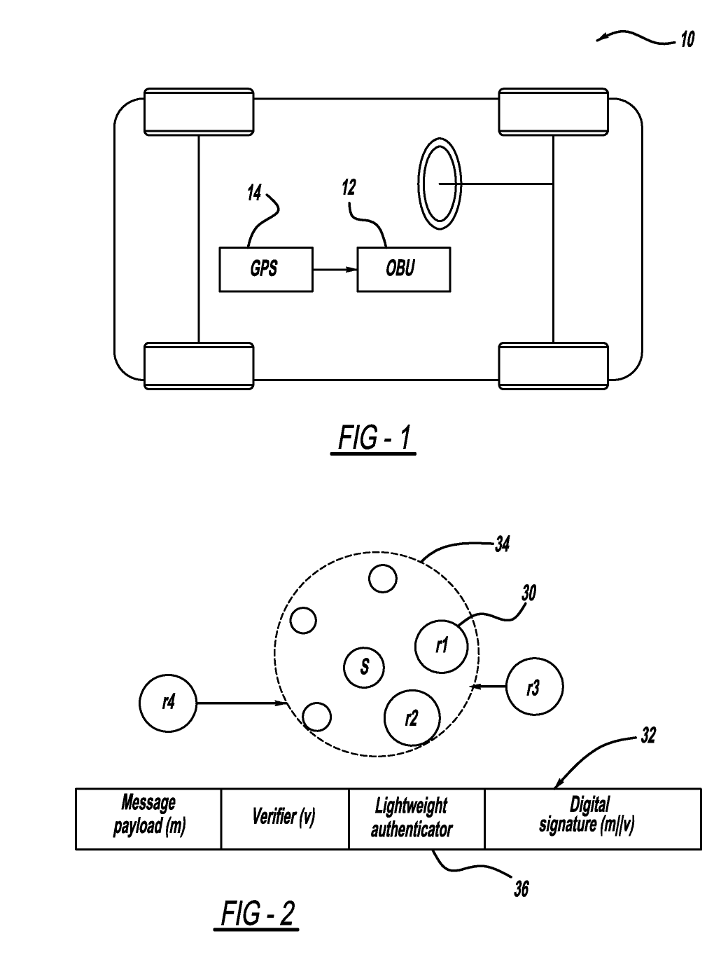

FIG. 1 illustrates a plan view of a vehicle 10 including an on-board unit (OBU) 12 for a V2X wireless communication system. The OBU 12 receives location information from a GPS receiver 14, and is able to communicate with other OBUs on other vehicles within a limited range.

The wireless communication system employs a technique referred to as trajectory authentication to address the problems set forth above for V2V communications. Using the proposed technique, each vehicle constructs a discretized representation of its trajectory, which captures its kinematic history to a tunable degree of accuracy and to a tunable extent in the past. This trajectory information is then signed using a Merkle-Winternitz one-time signature. Presently, with every periodic message, the sending vehicle transmits the usual application payload, a signed version of the trajectory as described, and a digital signature over all of the fields. The more accuracy and the history, the more the size of, or the number of bits required for, the discretized representation. This leads to a tradeoff between accuracy and history, and the communication overhead of the Merkle-Winternitz signature. Because Merkle-Winternitz signatures are computationally lightweight, receiving vehicles can authenticate useful trajectory information efficiently. Message loss is addressed by the discrete trajectory representation conveyed in the message that captures the kinematic history of the sending vehicle. In this manner, the proposed technique significantly improves the operation of V2V safety applications based on periodic message transmissions.

Suppose that for a given authentication mechanism, the average signing and verification times in seconds are denoted by T_{S} and Tᵥ, respectively. Also, Nₒᵤₜ can denote the rate at which the security layer receives outgoing messages to be signed per second, and Nᵢₙ can denote the rate at which the security layer receives incoming messages to be verified per second. Because the utilization of the OBU 12 on the vehicle 10 is at most 100%, it follows that for a stable system NₒᵤₜT_{S}+NᵢₙTᵥ<1.

Persistent applications, such as BWS or CCW, are based on vehicles transmitting on a continual basis at the rate of 10 messages per second. As vehicle densities increase, the rate of incoming messages to be verified increases linearly with the number of neighboring vehicles, assuming no losses on the wireless medium. However, the rate of outgoing messages to be signed is always bounded by 10 messages per second. Note that while it is possible to authenticate every outgoing message with a PKI-based digital signature, it is not feasible to verify the digital signature of every received message at a node. Hence, the focus of efficient broadcast authentication should be on efficient verification mechanisms. For example, consider 50 vehicles in the vicinity of a given tagged vehicle, each transmitting 10 messages per second. The tagged vehicle receives 500 messages to be verified every second. Hence, for a stable system, the average verification time should be less than 2 msec.

For authentication of broadcast messages, a variety of efficient mechanisms have been proposed. Broadcast authentication mechanisms require the attribute that only the sender is able to generate the signature, and any receiver is able to only verify the signature. While asymmetric key cryptography can provide all of the primitives required for broadcast authentication, primitives based on symmetric key cryptography are preferred because of their efficiency. Symmetric key primitives are 3-5 orders of magnitude faster than their asymmetric counterparts.

Broadcast authentication mechanisms can be categorized as digital signatures based on asymmetric key cryptography, such as ECDSA, timed efficient stream loss-tolerant authentication (TESLA), and one-time signatures. The primary drawback of ECDSA is that the time to sign and verify a message is large. TESLA piggybacks on a PKI-based digital signature mechanism, via a digitally signed message, the sender conveys an authentic version of the key disclosure schedule message. One-time signatures piggyback on a PKI-based digital signature mechanism, and are constructed based on the difficulty of inverting one-way functions. Initially, the sender conveys verifying in an authentic manner to all of the receivers, and the one-time signature for subsequent messages is based on this verifying information.

An authenticator is classified as lightweight based on the amount of time expended to generate or verify it. In particular, the sender appends every outgoing message with two authenticators, a lightweight authenticator and a digital signature. As noted previously, in the V2V context, efficient verification techniques are needed for broadcast messages. Nodes that come into the transmission range of a sender verify the digital signature, which enables them to verify the lightweight authenticator for subsequent messages. This is shown in FIG. 2 where an illustration of node mobility is shown by nodes 30 when each message 32 is appended with dual authenticators. Nodes 30 that come into the transmission range 34 on the sender S verify the digital signature of the message 32. This enables them to verify the lightweight authenticator 36 for subsequent messages transmitted by the sender.

Applications, such as BSW and CCW, require V2V-equipped vehicles to be aware of the kinematical history of neighboring vehicles. This is accomplished by an enabler application (i.e., a mechanism for embedding and broadcasting trajectory and kinematical vehicle information), referred to as neighborhood vehicle tracking (NVT). The NVT application resident on each V2V-equipped vehicle periodically broadcasts trajectory and kinematical information about the vehicle at the rate of approximately 10 messages per second per vehicle.

Consider an NVT application running on a vehicle. The application layer sends to the security layer a message containing the 2-dimensional coordinates of the vehicle at discrete times ti. Assume that the generation of messages by the NVT application is loosely periodic, i.e., tᵢ₊₁−tᵢ≈T₀. For the sake of concreteness, the format of the unsigned message sent by the application layer to the security layer is given below. It should be clear that this format entails no loss of generality.

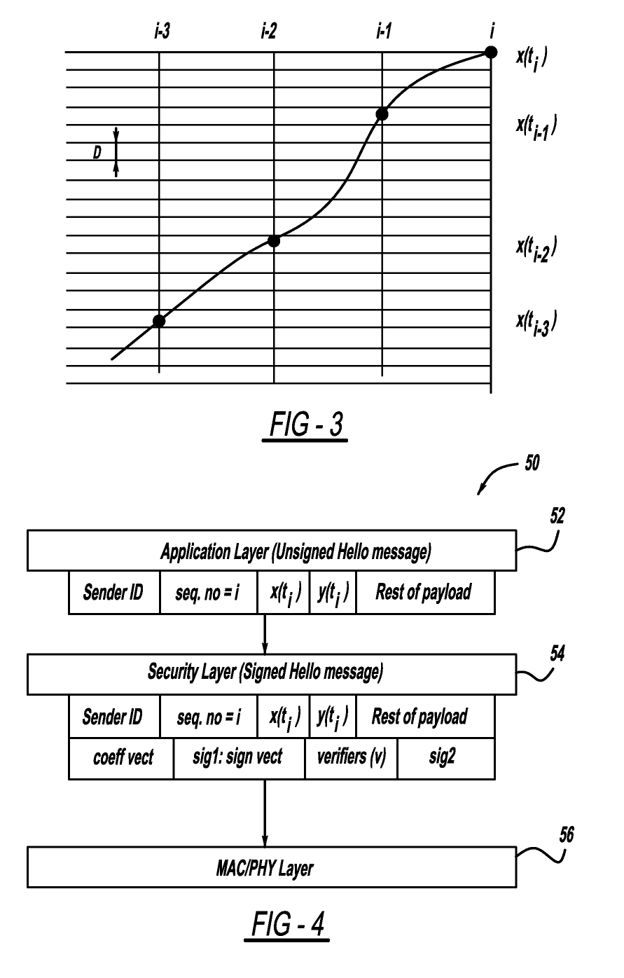

For an Unsigned Hello message, identified as sender ID, Sequence number=i,x(tᵢ),y(tᵢ), rest of payload, the values (x(tᵢ),y(tᵢ)) are the 2-dimensional co-ordinates of the vehicle at time tᵢ, and the message has the sequence number i. The last part of the message is the rest of the payload of the periodic message excluding the first four fields. FIG. 4 depicts one component of the trajectory of the vehicle constructed using all of the Hello messages. Particularly, FIG. 3 shows vehicle trajectories in the x-coordinate of the vehicle as a function of time or sequence number.

The following assumptions are made regarding the maximum vehicle speed and the resolution required by the NVT application. The maximum vehicle speed is denoted as Vₘₐₓ meters/sec. The resolution required by the NVT application is D meters. Also, the period of the NVT application is T₀ seconds. Note that the maximum distance traveled in either of the x- or y-dimensions in one period is given by Dₘₐₓ=T₀Vₘₐₓ. Hence, for all 1≦m≦(k−1), |x(tᵢ₋ₘ)−x(tᵢ₋ₘ₊ᵢ)|≦Dₘₐₓ, and |y((tᵢ₋ₘ)−y(tᵢ₋ₘ₊₁))|<Dₘₐₓ. For example, if Vₘₐₓ=180 kilometers per hour, which equals 50 meters/sec, T₀=100 ms, then Dₘₐₓ=T₀Vₘₐₓ=5 meters.

Let [y] denote the ceiling function i.e., the smallest integer greater than or equal to the real number y. For 0≦m≦k−1, let

$${P}_{m} = ⌈ \frac{( x ( {t}_{i - m} ) - x ( {t}_{i} ) )}{D} ⌉ .$$

The integer Pₘ represents the relative distance between the positions of the vehicle at times tᵢ and tᵢ₋ₘ, i.e., (x(tᵢ₋ₘ)−x(tᵢ)), to a resolution of D meters. A discrete representation of the trajectory of the sending vehicle is thus given by the sequence of numbers Qₘ, 1≦m≦k−1, where Q_{M}=P_{M}−Pₘ₋₁. A bound on the sequence of numbers Qₘ in terms of

$$α = ⌈ \frac{{D}_{max}}{D} ⌉$$

is provided.

Suppose that Qₘ≧0 which means that x(tᵢ₋ₘ)≧x(tᵢ₋ₘ₊₁). Since it is known that |x(tᵢ₋ₘ)−x(tᵢ₋ₘ₊₁)|≦Dₘₐₓ, this implies that x(tᵢ₋ₘ)−x(tᵢ₋ₘ₊₁)≦Dₘₐₓ. In this case:

$$\begin{matrix}{Q}_{m} = {P}_{m} - {P}_{m - 1} & ( 1 ) \\ = ⌈ \frac{x ( {t}_{i - m} ) - x ( {t}_{i} )}{D} ⌉ - ⌈ \frac{x ( {t}_{i - m + 1} ) - x ( {t}_{i} )}{D} ⌉ & ( 2 ) \\ \leq ⌈ \frac{x ( {t}_{i - m} ) - x ( {t}_{i} )}{D} - ⌈ \frac{x ( {t}_{i - m + 1} ) - x ( {t}_{i} )}{D} ⌉ ⌉ & ( 3 ) \\ = ⌈ \frac{x ( {t}_{i - m} ) - x ( {t}_{i - m + 1} )}{D} ⌉ & ( 4 ) \\ \leq ⌈ \frac{{D}_{max}}{D} ⌉ = α & ( 5 )\end{matrix}$$

Where equation (2) follows from the definition of Qₘ and Pₘ, equation (3) follows from the fact that for real numbers a and b, [a−b]−1≦[a]−[b]≦[a−b] by and equation (5) since x(tᵢ₋ₘ)−x(tᵢ₋ₘ₊₁)≦Dₘₐₓ.

Suppose that Qₘ<0, which implies that x(tᵢ₋ₘ)−x(tᵢ₋ₘ₊₁). Since it is known that |x(tᵢ₋ₘ)−x(tᵢ₋ₘ₊₁)|≦Dₘₐₓ, this implies that x(tᵢ₋ₘ)−x(tᵢ₋ₘ₊₁)≧−Dₘₐₓ. In this case:

$$\begin{matrix}{Q}_{m} = {P}_{m} - {P}_{m - 1} & ( 6 ) \\ = ⌈ \frac{x ( {t}_{i - m} ) - x ( {t}_{i} )}{D} ⌉ - ⌈ \frac{x ( {t}_{i - m + 1} ) - x ( {t}_{i} )}{D} ⌉ & ( 7 ) \\ \leq ⌈ \frac{x ( {t}_{i - m} ) - x ( {t}_{i} )}{D} - \frac{x ( {t}_{i - m + 1} ) - x ( {t}_{i} )}{D} ⌉ - 1 & ( 8 ) \\ = ⌈ \frac{x ( {t}_{i - m} ) - x ( {t}_{i - m + 1} )}{D} ⌉ - 1 & ( 9 ) \\ \leq ⌈ \frac{{D}_{max}}{D} ⌉ - 1 = - ( a + 1 ) & ( 10 )\end{matrix}$$

Where, equation (7) follows from the definition of Qₘ and Pₘ, equation (8) follows from the fact that for real numbers a and b, [a−b]−1≦[a]−[b]≦[a−b] and equation (10) since x(tᵢ₋ₘ)−x(tᵢ₋ₘ₊₁)≧−Dₘₐₓ.

Hence, it follows that the integers Qₘ, 1≦m≦k−1 can take on at most 2(α+1) distinct values that lie within the range −(α+1)≦Qₘ≦α. Let Δ=2(α+1). Thus, the discretized trajectory representation of the x-coordinates consists of k−1 integers, such that each integer can take on Δ distinct values. Since each integer can take on Δ distinct values, it can be represented in [log₂(Δ)] bits. Similarly, the y-coordinates can also be represented using k−1 integers, such that each integer can take on at most Δ distinct values. Note that the extent to which the kinematical history is to be captured, it is tunable by increasing or decreasing k, and the accuracy can be controlled by tuning D which would increase or decrease α.

The following discussion concerns trajectory authentication that significantly improves the performance of V2V safety applications based on periodic message transmissions. For robustness to message loss, authentic discretized trajectory information was conveyed with periodic messages transmitted by V2V safety applications. This enables the vehicles receiving periodic messages to reconstruct an approximate trajectory of the sending vehicle in spite of frequent message loss. Lightweight geographic authentication is extended to construct a lightweight geographic authentication mechanism using the technique of the Merkle-Winternitz one-time signature mechanism. In this regard, a signature is referred to as lightweight based on the amount of computational resources required to process the signature. The lightweight signature authenticates only the trajectory information contained within the message. Particularly, it authenticates only the first four fields, i.e. sender ID, sequence number, and x-axis and y-axis coordinates of the Unsigned Hello message. The general format of the message after it is processed by the security layer of the sender is discussed below. The proposed authentication mechanism appends up to two signatures to each message.

FIG. 4 is a representation of a message protocol 50 including an application layer 52, a security layer 54 and a physical layer 56.

Consider a Signed Hello message identified as sender ID, sequence number=i,x(tᵢ), y(tᵢ), rest of payload, coefficient vector, verifiers (v), signed vectors, signature 1, signature 2. At the sender, the high-level steps taken by the security layer 54 in processing the message Unsigned Hello that is received from the application layer 52 are described below. The discrete representation of the trajectory of the sending vehicle yields the coefficients Qₘ. 1≦m≦k−1. This is placed in the coefficient vector. The lightweight signature is then computed based on the coefficients computed above, and the random numbers associated with the sender ID and sequence number. The lightweight signature is based on the Merkle-Winternitz one-time signature mechanism. The verifiers v are used to authenticate the components of the lightweight signature for subsequent sequence numbers in the manner described below. Note that the verifiers v need not be present in every Signed Hello message. The digital signature (sig 2) is the standard PKI-based digital signature over the entire unsigned message augmented by coefficient vector, sign vector and the verifiers v. The algorithms involved in each of these steps are described in detail below. These include a discrete representation of the trajectory of the sending vehicle, and the Merkle-Winternitz one-time signature mechanism.

Consider the 2-dimensional positions of the vehicle at the current time tᵢ and the previous times tᵢ₋ₘ, where m=1, . . . , (k−1). Denote the k positions by (x(tᵢ₋ₘ), y(tᵢ₋ₘ)),0≦m≦k−1. To obtain a discrete representation of the trajectory of the vehicle, the sender computes the following coefficients.
1) Treat each of the x- and y-dimensions independently as a function of the sequence number. For the x-axis, consider the sequence of positions x(tᵢ₋ₘ), 0≦m≦k−1.
2) Consider the sequence of points, Qₘ^{x}, 1≦m≦k−1, which is computed as follows.

$$For 0 \leq m \leq k - 1 , {P}_{m}^{x} = ⌈ \frac{x ( {t}_{i - m} ) - x ( {t}_{i} )}{D} ⌉ ; and$$

$$For 1 \leq m \leq k - 1 , {Q}_{m}^{x} = {P}_{m - 1.}^{x}$$

3) Perform a similar operation for the y-axis co-ordinates y(tᵢ₋ₘ), 0≦m≦k−1. Consider the sequence of points in Qₘ^{y}, 1≦m≦k−1, which is computed as follows.

$$For 0 \leq m \leq k - 1 , {P}_{m}^{y} = ⌈ \frac{y ( {t}_{i - m} ) - y ( {t}_{i} )}{D} ⌉ ; and$$

$$For 1 \leq m \leq k - 1 , {Q}_{m}^{y} = {P}_{m - 1.}^{y}$$

4) The coefficients corresponding to a discrete representation of the trajectory of the sending vehicle are given by the coefficient vector being (Q₁^{x}, . . . , Qₖ₋₁^{x}), (Q₁^{y}, . . . , Qₖ₋₁^{y}).

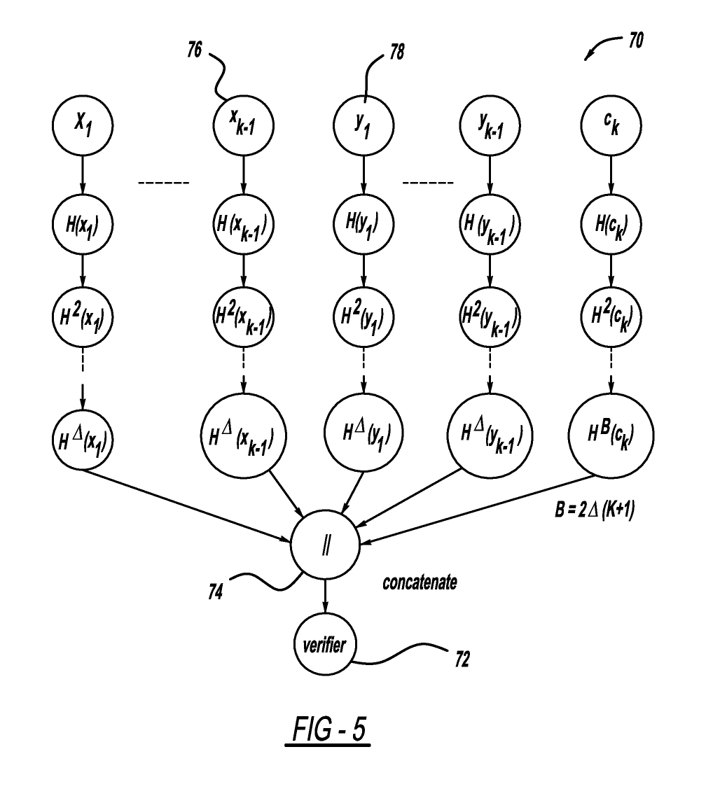

A one-time signature mechanism similar to the Merkle-Winternitz one time signature mechanism is used. FIG. 5 is a representation of a Merkle-Winternitz one-time signature mechanism 70 including a verifier node 72 and a concatenate node 74. The mechanism 70 also includes columns of x-coordinate nodes 76 and columns of y-coordinate nodes 78.

The random numbers used in the lightweight authentication mechanism are generated and authenticated as follows. At the security layer 54, the sender, denoted by sender ID, generates a total of 2(k−1)+1 random numbers for each sequence number. The random numbers corresponding to the sequence number j are denoted by the set:

R^{j}={rx₁^{j}, . . . ,rxₖ₋₁^{j}}∪{ry₁^{j}, . . .,ryₖ₋₁^{j}}∪{rc^{h}} (11)

Recall that Δ=2(a+1). From the perspective of the sender, the verifier v associated with sequence number j is denoted by V^{j}, where:

V^{j}=H(H^{Δ}(rx₁^{j})∥ . . . ∥H^{Δ}(rxₖ₋₁^{j})∥H^{Δ}(ry₁^{j})∥ . . . ∥H^{Δ}(ryₖ₋₁^{j})∥H^{2·(k-1)·Δ}(rcₖ^{j})) (12)

Consider the following message sent by the NVT application to the security layer, Unsigned Hello (Sender ID, seq. no.=i,x(tᵢ),y(tᵢ), Rest of payload.) To sign this message, an OBU does the following. Suppose two coefficients corresponding to the discrete representation of the trajectory of the vehicle are given by the coefficient vector (coeff vect) equal to (Q₁ₓ, . . . , Qₖ₋₁^{x}), (Q₁^{y}, . . . , Qₖ₋₁^{y}). The lightweight signature on the Unsigned Hello message is the one-time signature corresponding to the coefficients of the discrete representation of the senders' trajectory.

The sender determines the lightweight signature based on the above coefficients as follows. Sign vector=sig 1=(σ₁^{x},σ₂^{x}, . . . ,σₖ₋₁^{x}), (σ₁^{y},σhd 2^{y}, . . . ,σₖ₋₁^{y}), (σₖ^{xy}), where for 1≦m≦k−1, increment Qₘ^{x} and Qₘ^{y} by the constant (α+1) so as to make then non-negative. For all 1≦m≦(k−1), σₘ^{x}=H^{Q}^{ₘ}^{^{x}}(rxₘⁱ), for all 1≦m≦(k−1), σₘ_{y}=H^{Q}^{ₘ}^{^{y}}(ryₘⁱ); and σₖ^{xy}=H^{(2(k-1)Δ-Σ}^{ₘ₌₁}^{^{k−1}}^{(Q}^{ₘ}^{^{x}}^{+Q}^{ₘ}^{^{y}}⁾⁾(rcⁱ).

For each of the subsequent sequence numbers i+j,j=1, . . . Q (where Q=20), compute the corresponding verifying information V^{i+j}. Let the verifier v to be appended to the unsigned message be given by v ={V^{i+j}, 1≦j≦Q}. Recall that the verifiers v need not be present in every message.

The digital signature (sig 2) of the message is a PKI-based digital signature on the Unsigned Hello message appended with the following Coefficient vector (coeff vect), Lightweight signature (sign vector=sig 1), and verifiers v.

Upon receipt of a signed message Signed Hello, the security layer of the receiver can verify either the digital signature (sig 2) or the lightweight signature (sig 1). Verifying the digital signature of a received message involves the usual PKI-based operations. As discussed, the digital signature of the message includes the coefficients computed from the discrete representation of the trajectory of the vehicle. After verifying the digital signature of a message, the receiver obtains authentic information pertaining to the position of the vehicle sending the message during the k time instants in the immediate past. This resolution of this location information is D meters. The process of recovering approximate location information involves the following steps, and is specified for the x-axis co-ordinates only. Since the PKI-based digital signature of this message has been verified, the coefficients (Q₁^{x}, . . . ,Qₖ₋₁^{x}) have been determined to be authentic. Next, compute Pₘ from these authentic values via the equation Pₘ=Σᵤ₌₁^{m}Qᵤ. Finally, to within a resolution of D meters, x(tᵢ₋ₘ)≈x(tᵢ)+D·Pₘ. To be more precise, x(tᵢ)+D·(Pₘ−1)≦x(tᵢ₋ₘ)≦x(tᵢ)+D·Pₘ.

To verify the lightweight signature of the received message, the receiver performs the following actions. The verification of the lightweight signature is feasible only if the receiver has beforehand obtained the authentic value of the verifier corresponding to this sequence number and sender ID via a digital signature verification of a message containing the verifier v. In addition, the verification of the lightweight signature is feasible only if the receiver has beforehand authenticated the position, denoted by (x′_{S}(i−m),y′_{S}(i−m)), of the sending vehicle for an earlier time tᵢ₋ₘ, for some 1≦m≦(k−1). This authentication at time tᵢ₋ₘ could have been done using digital signature verification or lightweight authentication. Lightweight authentication only gives confidence in the displacement from a previously authenticated reference position to a resolution of D meters. Thus, if the reference position was digitally authenticated, then the advertised location in the current message can be thought of as being correct up to a resolution of D meters. However, if the reference position was authenticated in a lightweight fashion, with the resolution of lD meters for some integer l, then the location in the current message can be trusted to be correct up to a resolution of (l+1) D meters.

Let the components of the lightweight signature associated with the message given by coefficient vector=(Q₁^{x′}, . . . ,Qₖ₋₁^{x}^{¹}), (Q₁^{y}^{¹}, . . . , Qₖ₋₁^{y}^{¹}), and sign vect=(σ₁^{x′}, . . . ,σₖ₋₁^{x}^{¹},σ₁^{y′}, . . . ,σₖ₋₁^{y′},σ′ₖ).

Authenticate the random numbers contained within the lightweight signature with the sender ID and the sequence number i in the manner described below:

Increment each of the values Qₘ^{x′} and Qₘ^{y′} by the constant α+1 so as to make them non-negative;

For 1≦m≦k−1, compute vₘ^{x′}=H^{Δ-Q}^{ₘ}_{_{x′}}(σₘ^{x′}) and v ₘ^{y′}=H^{Δ-Q}ₘ^{y′}(σₘ^{y′});

Compute v ′ₖ=H^{Σ}^{ᵤ₌₁}^{^{k−1}}^{(Q}^{ᵤ}^{^{x′}}^{+Q}^{ᵤ}^{^{y′}}⁾(σ′ₖ);

Compute (v ₁^{x′}∥v ₂^{x′}∥ . . . ∥v ₖ₋₁^{x′}∥v ₁^{y′}∥v ₂^{y′}∥ . . . ∥vₖ₋₁^{y′}∥v′ₖ);

Verify that H(z)=verifier (sender ID, sequence number=i); and

The above steps imply that coefficient vector (Q₁^{x′}, . . . ,Qₖ₋₁^{x′}), (Q₁^{y′}, . . . ,Qₖ₋₁^{y′}) is authentic.

The verification of the lightweight signature is feasible if the receiver has beforehand authenticated the position, denoted by (x′_{S}(i−m),y′_{S}(i−m)), of the sending vehicle for an earlier time tᵢ₋ₘ, for some (i.e., at least one) 1≦m≦(k−1).

Compute the value Pₘ^{x′}=Σᵤ₌₁^{m}Qᵤ^{x′} and Pₘ^{y′}=Σᵤ₌₁^{m}Qᵤ^{y′}.

Now, depending on how the reference position (x′_{S}(i−m),y′_{S}(i−m)) was authenticated, the verification step is carried out as follows:

For digital signature verification, verify that Pₘ^{x′}=

$$⌈ \frac{{x}_{S}^{′} ( i ) - {x}_{S}^{′} ( i - m )}{D} ⌉ and {P}_{m}^{{y}^{′}} = ⌈ \frac{{y}_{S}^{′} ( i ) - {y}_{S}^{′} ( i - m )}{D} ⌉ ,$$

where (x′_{S}(i),y′_{S}(i)) denotes the advertised position in the current message;

For lightweight authentication, verify that

$${P}_{m}^{{x}^{′}} ∈ ( ⌈ \frac{{x}_{S}^{′} ( i ) - {x}_{S - UB}^{′} ( i - m )}{D} ⌉ , ⌈ \frac{{x}_{S}^{′} ( i ) - {x}_{S - LB}^{′} ( i - m )}{D} ⌉ ) and$$

$${P}_{m}^{{y}^{′}} ∈ ( ⌈ \frac{{y}_{S}^{′} ( i ) - {y}_{S - UB}^{′} ( i - m )}{D} ⌉ , ⌈ \frac{{y}_{S}^{′} ( i ) - {y}_{S - LB}^{′} ( i - m )}{D} ⌉ ) ,$$

where (x′_{S}(i),y′_{S}(i)) denotes the advertised position in the current message; and

Here, x′_{S-LB}(i−m) is the lower bound of the confidence interval for the x-coordinate of the position at time tᵢ₋ₘ, while x′_{S-UB}(i−m) is the upper bound of the confidence interval. The y-coordinate bounds are defined similarly. The way in which the confidence interval is set upon lightweight authentication is described in the next step.

Now, set x′_{S-LB}(i),x_{S-UB}(i),y′_{S-LB}(i) and y′_{S-UB}(i) appropriately depending on the confidence of the lightweight authentication. This is explained in detail below.

The generation and verification of the lightweight signature can be examined to determine the performance of the proposed authentication mechanism in terms of the time required to generate and verify the lightweight signature. At the sender, the generation of the digital signature and the lightweight signature incurs the following computation times. To generate the digital signature involves one PKI-based digital signature generation per packet. To generate the lightweight signature the following computations are involved. For a single packet, the sender has to compute 2(k−1) hash chains of length Δ each, and of length 2Δ(k−1). This is equivalent to 4Δ(k−1) hash function computations of a block size equal to the output of the hash function. In addition, the sender has to concatenate 2k−1 hashed values and compute a further hash of the result. This is equivalent to 2k−1 hash computations of a block size equal to the output of the hash function used. Thus, for a single packet the sender has to compute a total of 2(2Δ+1)(k−1)+1 hash computations.

At the receiver, the verification of the digital signature and the lightweight signature incurs from the following computation times. The verification of the digital signature involves one PKI-based digital signature verification per packet. The verification of the lightweight signature involves exactly one half of the number of hash operations that the sender carried out to get all the hash values to compute the verifier, following which it involves exactly the same number of hash operations to actually compute the verifier ν. Thus, the computational overhead is equivalent to 2(Δ+1)(k−1)+1 hash computations of a block size equal to the output of the hash function.

For a batch of Q packets, the sender initially transmits the corresponding verifying information containing Q verifiers. If the verifier information is sent only once every Q packets, then the computation overhead would be low, but if there are packet losses, then the receivers would have to resort to a large number of PKI verifications. If it is sent once in \hat{Q} messages, where \hat{Q}<Q, then the overhead due to the verifiers would be

$$\frac{\vert H ( . ) \vert Q}{\hat{Q}} .$$

The overhead incurred in the lightweight signature per packet is a total of 2(k−1) coefficients and a total of 2k−1 hash values, which adds up to 2·(k−1)·[log₂(Δ)]+(2k−1)·|H(.)| bits.

The security properties of the lightweight authentication mechanism are now examined. Recall that the lightweight signature protects the location information present in the Signed Hello message. Suppose node A has authentic location information pertaining to node B for the time instants tᵢ₋ₘ, 1≦m<k. The location information is assumed to be authentic but approximate to within error of D meters. The location information at the same time instant is denoted tᵢ₋ₘ, 1≦m<k, as (x_{B}(tᵢ₋ₘ),y_{B}(tᵢ₋ₘ)).

Suppose a receiver R receives a message with the following fields: sender ID=S, sequence number=i, (x(tᵢ),y(tᵢ))=(x′_{S}(i),y′_{S}(i)). Suppose the receiver R has beforehand obtained the authentic value of the verifier v corresponding to sender ID=S and sequence number=i via a digital signature verification of a message containing the verifier v. In addition, suppose the receiver R has beforehand authenticated, via a digital signature verification, the position, denoted by (x′_{S}(i−m),y_{S}(i−m)), of the sending vehicle for an earlier time tᵢ₋ₘ, for some, or at least one, 1≦m≦(k−1). If the lightweight signature verification of this message is successful, then receiver R is able to infer the x-axis and y-axis coordinates of the position of the sending vehicle at time tᵢ to an accuracy of D meters. In particular:

x′_{S}(i)∈(x′_{S-LB}(i),x′_{S-UB}(i)) (13)

y′_{S}(i)∈(y′_{S-LB}(i),y′_{S-UB}(i)) (14)

Where

x′_{S-LB}(i)=D·(Pₘ^{x′}(i)−1)+x′_{S}(i−m) (15)

x′_{S-UB}(i)=D·Pₘ^{x′}(i)+x′_{S}(i−m) (16)

y′_{S-LB}(i)=D·(Pₘ^{y′}(i)−1)+y′_{S}(i−m) (17)

y′_{S-UB}(i)=D·Pₘ^{y′}(i)+y′_{S}(i−m) (18)

For each 1≦u≦k−1(u≠m), receiver R is able to infer the x-axis and y-axis co-ordinates of the position of the sending vehicle at time tᵢ₋ᵤ to an accuracy of 2·D meters. In particular:

x′_{S}(i−u)∈(x′_{S-LB}(i−u), x′_{S-UB}(i−u)) (19)

y′_{S}(i−u)∈(y′_{S-LB}(i−u), y′_{S-UB}(i−u)) (20)

Where,

x′_{S-LB}(i−u)=D·(Pₘ^{x′}(i)−Pᵤ^{x′}(i))+x′_{S}(i−m)−D (21)

x′_{S-UB}(i−u)=D·(Pₘ^{x′}(i)−Pᵤ^{x′}(i))+x′_{S}(i−m)+D (22)

y′_{S-LB}(i−u)=D·(Pₘ^{y′}(i)−Pᵤ^{y′}(i))+y′_{S}(i−m)−D (23)

y′_{S-UB}(i−u)=D·(Pₘ^{y′}(i)−Pᵤ^{x′}(i))+y′_{S}(i−m)+D (24)

Recall that the receiver R has beforehand authenticated via a PKI-based digital signature verification the position, denoted by (x′_{S}(i−m),y′_{S}(i−m)), of the sending vehicle for an earlier time tᵢ₋ₘ, for some 1≦m≦(k−1). This position (x′_{S}(i−m),y′_{S}(i−m)) is the anchor, or reference, through which the receiver infers bounds on the position of the sender S at time tᵢ and times tᵢ₋ᵤ, 1≦u≦k−1.

Suppose the coefficients embedded in the trajectory representation of the NVT message transmitted by sender S with the sequence i be denoted by coefficient vector=(Q₁^{x′}(i), . . . ,Qₖ₋₁^{x′}(i)),(Q₁^{y′}(i), . . . ,Qₖ₋₁^{y′}(i)). If the lightweight signature based on the Merkle-Winternitz one-time signature mechanism verifies, then it implies that the coefficient vector (Q₁^{x′}(i), . . . ,Qₖ₋₁^{x′}(i)),(Q₁^{y′}(i), . . . Qₖ₋₁^{y′}(i)) is authentic. It follows that the values pᵤ^{x′}(i) and P_{U}^{y′} are also authentic for each value of 1≦u≦(k−1), where Pᵤ^{x′}(i)=Σv=1^{u}Qᵥ^{x′}(i) and Pᵤ^{y′}(i)=Σᵥ₌₁^{u}Qᵥ ^{y′}(i).

Via a PKI-based digital signature verification of the message with sequence number i−m, the receiver infers (x′_{S}(i−m),y′_{S}(i−m)) to be authentic. Via a lightweight signature verification of the message with sequence number i, the receiver infers that Pₘ^{x′}(i) and Pₘ^{y′}(i) are authentic. Recall that by definition

$${P}_{m}^{{x}^{′}} ( i ) = ( \frac{{x}_{s}^{′} ( i ) - {x}_{s}^{′} ( i - m )}{D} ) .$$

Hence, the receiver R can infer the following bound on x′_{S}(i) as:

D·(Pₘ^{x′}(i)−1)<x′_{S}(i)−x′_{S}(i−m)≦D·Pₘ^{x′}(i) (25)

D·(Pₘ^{x′}(i)−1)+x′_{S}(i−m)<x′_{S}(i)≦D·Pₘ^{x′}(i)+x′_{S}(i−m) (26)

The lightweight signature verification implies that the entire coefficient vector is authentic. Hence, for each 1≦u≦k−1, Pᵤ^{x′}(i) and Pᵤ^{x′}(i) are authentic. Recall that by definition,

$${P}_{u}^{{x}^{′}} ( i ) = ( ⌈ \frac{{x}_{S}^{′} ( i ) - {x}_{S}^{′} ( i - u )}{D} ⌉ ) .$$

Hence, the receiver can infer the following bound on x′_{S}(i−u):

D·(Pᵤ^{x′}(i)−1)<x′_{S}(i)−x′_{S}(i−u)≦D·Pᵤ^{x′}(i) (27)

Combining the above sets of inequalities, the receiver determines the following bounds on the position (x′_{S}(i−u)), (y′_{S}(i−u)), (1≦u≦k−1,u≠m) in terms of the anchor position (x′_{S}(i−m)), (y′_{S}(i−m)). In particular:

D·(Pᵤ^{x′}(i)−Pᵤ^{x′}(i))+x′_{S}(i−m)−D<x′_{S}(i−u) (28)

x′_{S}(i−u)<D·(Pₘ^{x′}(i)−Pᵤ^{x′}(i))+x′_{S}(i−m)+D (29)

A sequence of lightweight signature verifications will result in a linear increase in the uncertainty associated with the position of the sending vehicle in each of the x-axis and y-axis co-ordinates. The uncertainty in the position of the vehicle is with respect to a position anchor that has been authenticated via a PKI-based digital signature verification by the receiver.

Suppose a receiver R receives a message with the following fields: sender ID=S, sequence number=i, (x(tᵢ),y(tᵢ))=(x′_{S}(i),y′_{S}(i)). Suppose the receiver R has beforehand obtained the authentic value of the verifier v corresponding to sender ID=S and sequence number=i via a digital signature verification of a message containing the verifier v. In addition, suppose the receiver R has beforehand authenticated, via a lightweight signature verification, the position, denoted by (x′_{S}(i−m),y′_{S}(i−m)), of the sending vehicle for an earlier time tᵢ₋ₘ, for some, or at least one, 1≦m≦(k−1). Let the confidence interval for the lightweight authentication be denoted by x′_{S}(i)∈(x′_{S-LB}(i),x′_{S-UB}(i)) for the x-coordinate and by y′_{S}(i)∈(y′_{S-LB}(i),y′_{S-UB}(i)) for the y-coordinate. If the lightweight signature verification of this message is successful, then the receiver R is able to infer the x-axis and y-axis co-ordinates of the position of the sending vehicle at time tᵢ to an accuracy of D meters. In particular:

x′_{S}(i)∈(x′_{S-LB}(i),x′_{S-UB}(i) (30)

y′_{S}(i)∈(y′_{S-LB}(i),y′_{S-U}(i) (31)

Where,

x′_{S-LB}(i)=D·(Pₘ^{x′}(i)−1)+x′_{S-LB}(i−m) (32)

x′_{S-UB}(i)=D·Pₘ^{x′}(i)+x′_{S-UB}(i−m) (33)

y′_{S-LB}(i)=D·(Pₘ^{y′}(i)−1)+y′_{S-LB}(i−m) (34)

y′_{S-UB}(i)=D·Pₘ^{y′}(i)+y′_{S-UB}(i−m) (35)

For each 1≦u≦k−1(u≠m), the receiver R is able to infer the x-axis and y-axis co-ordinates of the position of the sending vehicle at time tᵢ₋ᵤ to an accuracy of 2·D meters. In particular:

x′_{S}(i−u)∈(x′_{S-LB}(i−u),x′_{S-UB}(i−u)) (36)

y′_{S}(i−u)∈(y′_{S-LB}(i−u),y′_{S-UB}(i−u)) (37)

Where,

x′_{S-LB}(i−u)=D·(Pₘ^{x′}(i)−Pᵤ^{x′}(i))+x′_{S-LB}(i−m)−D (38)

x′_{S-UB}(i−u)=D·Pₘ^{x′}(i)−Pᵤ^{x′}(i)+x′_{S-UB}(i−m)+D (39)

y′_{S-LB}(i−u)=D·(Pₘ^{y′}(i)−Pᵤ^{y′}(i))+y′_{S-LB}(i−m)−D (40)

y′_{S-UB}(i−u)=D·Pₘ^{y′}(i)−Pᵤ^{y′}(i)+y′_{S-UB}(i−m)+D (41)

The technique of trajectory authentication described so far provides a number of parameters that are tunable. These parameters can be tuned to achieve a desirable tradeoff between overhead for computation, storage and communication.

The discussion above has assumed that the application layer generates packets in an almost periodic fashion. However, the technique is readily extensible to the scenario when the application layer generates packets periodically. In this case, an additional assumption is required, particularly, that there is an upper bound on the inter-packet generation times. Then, there are two modifications that are required for the technique to work properly. First, the parameter

$$α = ⌈ \frac{{D}_{max}}{D} ⌉$$

needs to be redefined by Dₘₐₓ=TₘₐₓVₘₐₓ, where Tₘₐₓ is the maximum inter packet generation time. Second, because the packet generation times are not implicit from the sequence numbers, the sender could optionally convey discretized coefficients corresponding to the generation times of the packets. Thus, Qₛ^{t′} could be defined similar to Qₛ^{x′} and Qₛ^{y′}, and then the Merkle-Winternitz signature would be on the discretized representation of (x,y,t), as opposed to on the discretized representation of (x,y).

The techniques presented herein provide a simple and relatively loose acceptance criterion for verifying the lightweight authenticator based on the Merkle-Winternitz signature. Essentially, the lightweight authenticator was proposed to be accepted provided that the advertised location and the message was within a certain bound of a previously authenticated reference location. However, if multiple previously trusted locations are available, then the acceptance criterion could be made more stringent. In the case of disagreements, i.e., match with one location, but mismatch with respect to another, the packet could be stored and the digital signature verified later. If there are disagreements further, then the packet could be reported to the backend as a malicious packet.

The parameter D can be increased if the application layer at a given vehicle is not sensitive to location information outside a certain distance from the given vehicle. In particular, one effective strategy for choosing between lightweight signature verifications and heavyweight PKI verifications is as follows. The basic idea is that even if the uncertainty in the position of the sender S is quite large, such as within a 10 m by 10 m square, after a sequence of 5 lightweight verifications when D=2 m, there may be no need for the receiver R to determine the exact location of the sender S from the perspective of the CCW application if the nearest point on that square pertaining to the sender S is about 200 m from the receiver R. A receiver node R is performing a sequence of lightweight verifications for a given sender node S. After each lightweight verification, the uncertainty in the position of the node S in both the x- and y-dimensions increases linearly. The node R computes the distance between its current position, and the nearest possible location of the node S. If this is less than a certain threshold, then it invokes a heavyweight PKI-based verification to determine the exact location of the sender S. Otherwise, there is no need to invoke the PKI-based verification.

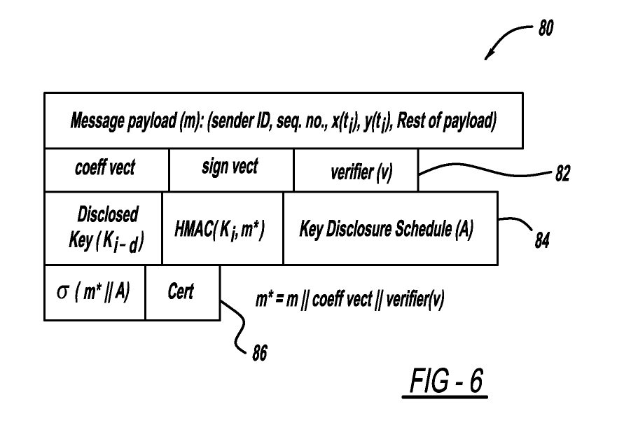

FIG. 6 is a representation of a message 80 appended with a PKI signature, a TESLA code and a one-time digital signature, according to another embodiment, where the message verification if further increased by adding the TESLA code to the message 80. The message 80 includes a verifier (v) 82 that provides commitment information pertaining to the one-time signature technique employed by the trajectory authentication. The message 80 also includes a key disclosure schedule (A) 84 that provides commitment information for the TESLA code. The key disclosure schedule (A) 84 and a digital certificate of sender 86 do not need to be present in every message.

It is to be understood that the above description is intended to be illustrative and not restrictive. Many alternative approaches or applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that further developments will occur in the arts discussed herein, and that the disclosed systems and methods will be incorporated into such further examples. In sum, it should be understood that the invention is capable of modification and variation and is limited only by the following claims.

The present embodiments have been particular shown and described, which are merely illustrative of the best modes. It should be understood by those skilled in the art that various alternatives to the embodiments described herein may be employed in practicing the claims without departing from the spirit and scope of the invention and that the method and system within the scope of these claims and their equivalents be covered thereby. This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

All terms used in the claims are intended to be given their broadest reasonable construction and their ordinary meaning as understood by those skilled in the art unless an explicit indication to the contrary is made herein. In particular, use of the singular articles such as “a”, “the”, “said”, etc. should be read to recite one or more of the indicated elements unless a claim recites an explicit limitation to the contrary.

What is claimed is:

1. A method for authenticating a message sent in a vehicle-to-vehicle communications system, said method comprising:
generating a message to be sent that includes a message payload, a verifier, a lightweight one-time signature and a public key infrastructure (PKI) based digital signature, said message including information representing the vehicle's trajectory and kinematic history;
transmitting the message from the vehicle; and
receiving the message at another vehicle that verifies the message using the lightweight authenticator and/or the digital signature.

2. The method of claim 1, wherein the one-time signature is a Merkle-Winternitz one-time signature.

3. The method of claim 1, wherein the authentication method is used in a blind spot warning system.

4. The method of claim 1, wherein the authentication method is used in a cooperative collision warning system.

5. The method of claim 1, wherein the message includes a timed efficient stream loss-tolerant authentication (TESLA) code.

6. A vehicle-to-vehicle communications system, comprising:
a broadcast authentication mechanism configured to append an outgoing message with a public key infrastructure (PKI) based digital signature and a one-time signature; and
an authentication mechanism configured to verify the digital signature and/or the lightweight authenticator transmitted by the broadcast authentication mechanism.

7. The system of claim 6, wherein the broadcast authentication mechanism transmits a message payload that includes real-time kinematics information that represents one or more of position, velocity and direction.

8. The system of claim 6, wherein the broadcast authentication mechanism further includes a mechanism for periodically broadcasting kinematical vehicle information.

9. The system of claim 6, wherein vehicle trajectory information is embedded into the outgoing message.

10. The system according to claim 6 wherein the authentication mechanism is a lightweight authentication mechanism.

11. The system of claim 10, wherein the lightweight authentication mechanism employs a Merkle-Winternitz one-time signature mechanism.

12. The system of claim 10, wherein the lightweight authentication mechanism authenticates only trajectory information embedded within the outgoing message.

13. The system of claim 11 wherein parameters corresponding to the authentication of the trajectory information using the Merkle-Winternitz one-time signature mechanism are tunable.

14. The system of claim 6, wherein the outgoing message includes a timed efficient stream loss-tolerant authentication (TESLA) code.

15. A method for vehicle-to-vehicle communications, comprising:
generating a periodic outgoing message that includes a message payload, a verifier, a lightweight authenticator and a digital signature; and
embedding within the message payload a discrete representation of a sending vehicle's trajectory.

16. The method of claim 15, wherein the discrete representation of the sending vehicle's trajectory includes two-dimensional coordinates of the sending vehicle at discrete times.

17. The method of claim 15, further including signing the discrete representation of the sending vehicle's trajectory using a Merkle-Winternitz one-time signature mechanism.

18. The method of claim 15, further including tuning parameters of the discrete representation of the sending vehicle's trajectory to balance computation and communication overhead.

19. The method of claim 15, wherein the outgoing message includes a timed efficient stream loss-tolerant authentication (TESLA) code.

20. The method of claim 15, wherein the method is used in a cooperative collision warning system.
